(19) United States
(12) Patent Application Publication
(10) Pub. No.: US 2026/0122160 A1
(43) Pub. Date: Apr. 30, 2026

(54) MOUNTING FRAME

(71) Applicant: TILTA INC., Burbank, CA (US)

(72) Inventors: Zhichao FENG, Shenzhen (CN); Wenping ZENG, Shenzhen (CN); Kefeng ZHOU, Shenzhen (CN)

(21) Appl. No.: 19/368,916

(22) Filed: Oct. 24, 2025

(30) Foreign Application Priority Data
Oct. 30, 2024 (CN) 202422642847.1

(51) Int. Cl. H04M 1/02

(52) U.S. Cl. CPC H04M 1/0203

(57) ABSTRACT

A mounting frame include a first housing and a second housing. The second housing includes a mounting space designed to accommodate an electronic device. An Assembly component includes a latching member and a latching groove. The latching member is positioned on either the first housing or the second housing, while the latching groove is on the other. The latching member can engage with the latching groove to secure the electronic device within the mounting space. During use, the user can first place the electronic device into the mounting space of the second housing, then position the first housing onto the second housing so that the latching member is engaged within the latching groove, thereby quickly connecting the first and second housings. For disassembly, the latching member is disengaged from the latching groove to swiftly disassemble the first and second housings.

### CROSS-REFERENCE TO RELATED APPLICATIONS

The present application for patent claims priority to and the benefit of pending Chinese Application No. 202422642847.1, filed Oct. 30, 2024, and hereby expressly incorporated by reference herein as if fully set forth below in its entirety and for all applicable purposes.

### TECHNICAL FIELD

The present disclosure pertains to the technical field of electronic device accessories, specifically to a mounting frame.

### INTRODUCTION

In daily life, electronic devices such as mobile phones and tablets have become indispensable tools. People frequently use these devices for activities like watching videos and working. The widespread adoption of electronic devices has led to the extensive use of electronic device accessories, such as protective cases. Currently, the typical method for installing a mobile phone into a protective case involves placing the phone inside the case and securing it with screws to ensure stable installation. However, this installation process is relatively cumbersome, resulting in a poor user experience.

### BRIEF SUMMARY

The present disclosure provides a mounting frame that enables quick assembly and disassembly of the first and second housings. This configuration allows for easy installation and removal of the mounting frame, enhancing overall convenience and efficiency during use.

Some aspects of the disclosure provide:

A mounting frame, including:
a first housing;
a second housing, including a mounting space for accommodating an electronic device;
an assembly component, including a latching member and a latching groove, wherein the latching member is positioned on either the first housing or the second housing, and the latching groove is on the other; the latching member is capable of engaging with the latching groove to secure the electronic device within the mounting space.

This disclosure introduces a mounting frame that simplifies the installation and removal of electronic devices. During use, the user can first place the electronic device into the mounting space of the second housing, then position the first housing onto the second housing so that the latching member is engaged within the latching groove, thereby quickly connecting the first and second housings. For disassembly, the latching member is disengaged from the latching groove to swiftly dissemble the first and second housings. In summary, the mounting frame described herein is easy to install and remove, thereby enhancing the user experience.

### BRIEF DESCRIPTION OF THE DRAWINGS

FIG. 1 is a diagram illustrating a mounting frame that includes a first housing and a second housing, with an electronic device installed, according to some aspects of the disclosure.

FIG. 2 is a diagram illustrating an exploded view of the mounting frame of FIG. 1 according to some aspects of the disclosure.

FIG. 3 is a diagram illustrating an enlarged view of section A in FIG. 2 according to some aspects of the disclosure.

FIG. 4 is a diagram illustrating the second housing according to some aspects of the disclosure.

FIG. 5 is a diagram illustrating an enlarged view of section B in FIG. 4 according to some aspects of the disclosure.

FIG. 6 is a diagram illustrating an enlarged view of section C in FIG. 4 according to some aspects of the disclosure.

FIG. 7 is a diagram illustrating the first housing according to some aspects of the disclosure.

FIG. 8 is a diagram illustrating an enlarged view of section D in FIG. 7 according to some aspects of the disclosure.

FIG. 9 is a diagram illustrating a cross-sectional view of the mounting frame during pre-installation according to some aspects of the disclosure.

FIG. 10 is a diagram illustrating a cross-sectional view of the mounting frame after installation according to some aspects of the disclosure.

### REFERENCE NUMERALS

10. Mounting Frame; 20. Electronic Device;
1. First Housing; 11. Second Inclined Surface; 12. Positioning Post;
2. Second Housing; 21. Mounting Space; 211. Mounting Opening; 212. Accommodating Groove; 213. Wire Passage Channel; 22. First Opening; 23. Second Opening; 24. First Positioning Groove; 241. Detent Ball; 25. Second Positioning Groove; 26. Trigger Key; 27. First Mounting Interface; 28. Second Mounting Interface; 29. Electrical Interface;
3. Assembly Component; 31. Latching Member; 311. Latching Hook; 3111. Sliding Groove; 32. Latching Groove; 33. Locking Member; 331. Actuating Part; 332. Locking Pin; 333. First Inclined Surface; 34. Locking Groove;
4. Flexible Flat Cable;
5. Protective Pad.

The objectives and functional features of this application will be further elaborated with reference to the accompanying drawings and in conjunction with exemplary embodiments.

### DETAILED DESCRIPTION

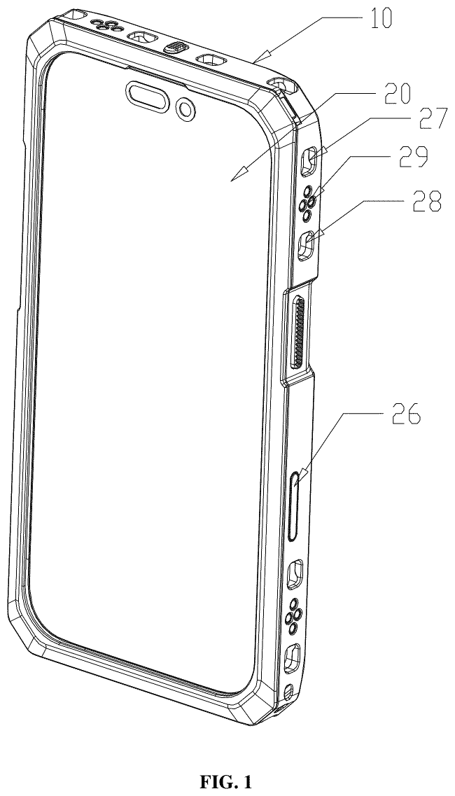

Referring to FIGS. 1-10, this disclosure provides a mounting frame 10 that simplifies the installation and removal of an electronic device 20. The mounting frame 10 includes a first housing 1, a second housing 2, and an assembly component 3. The second housing 2 includes a mounting space 21 designed to accommodate the electronic device 20, allowing the user to place the electronic device 20 within the mounting space 21. The assembly component 3 includes a latching member 31 and a latching groove 32 (e.g., a slot). The latching member 31 is positioned on either the first housing 1 or the second housing 2, and the latching groove 32 is on the other one of the first housing 1 or the second housing 2. The latching member 31 can engage with the latching groove 32 to secure the electronic device 20 within the mounting space 21.

In some examples, when using such products, after placing the electronic device 20 into the second housing 2, the user typically needs to cover the second housing 2 with the first housing 1 and then secure the first housing 1 and second housing 2 with screws for connection. This method ensures that the electronic device 20 is stably installed on the second housing 2, but the screw-fastening process requires considerable time for installation and disassembly, making it relatively inconvenient.

Some aspects of the disclosure introduce a mounting frame 10 that simplifies the installation and removal of the electronic device 20. During use, the user can first place the electronic device 20 into the mounting space 21 of the second housing 2, then position the first housing 1 onto the second housing 2 so that the latching member 31 engages with the latching groove 32, thereby quickly connecting the first housing 1 and second housings 2 together. For disassembly, the latching member 31 is disengaged from the latching groove 32 to swiftly dissemble the first housing 1 and second housing 2. The mounting frame 10 described herein is easy to install and remove, thereby improving the user experience.

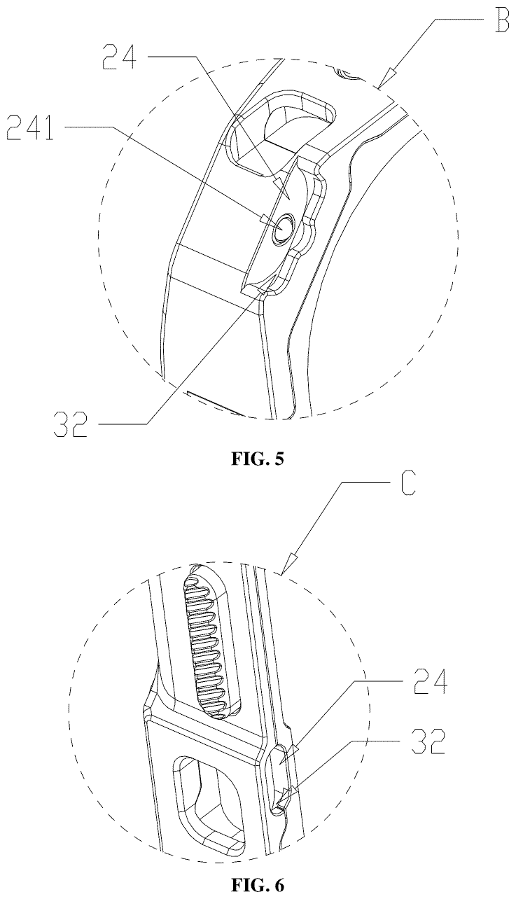

Referring to FIGS. 5-8, the latching member 31 and the latching groove 32 may be positioned on either the first housing 1 or the second housing 2. For illustrative purposes, the latching member 31 is positioned on the first housing 1, and the latching groove 32 is positioned on the second housing 2. When the first housing 1 slides relative to the second housing 2, the latching member 31 can be engaged within the latching groove 32. After the user places the electronic device 20 into the mounting space 21, the first housing 1 can be slid or glided relative to the second housing 2 to allow the latching member 31 to slide into and get engaged within the latching groove 32, thereby connecting the first housing 1 with the second housing 2. For disassembly, the first housing 1 can be slid relative to the second housing 2 in the opposite direction to disengage the latching member 31 from the latching groove 32, enabling the first housing 1 and second housing2 to be separated and the electronic device 20 to be removed. In some examples, the electronic device 20 can be a mobile phone or a tablet. The latching groove 32 may include multiple grooves distributed along both sides of the mounting space 21 of the second housing 2, or it may be continuous elongated grooves positioned on the second housing 2, specifically two elongated grooves on either side of the mounting space 21. Accordingly, the shape of the latching member 31 may be adaptively adjusted to match the shape of the latching groove 32.

In some aspects, a configuration where the latching member 31 is positioned on the second housing 2 and the latching groove 32 is positioned on the first housing 1 can be implemented by equivalently substituting the descriptions provided herein.

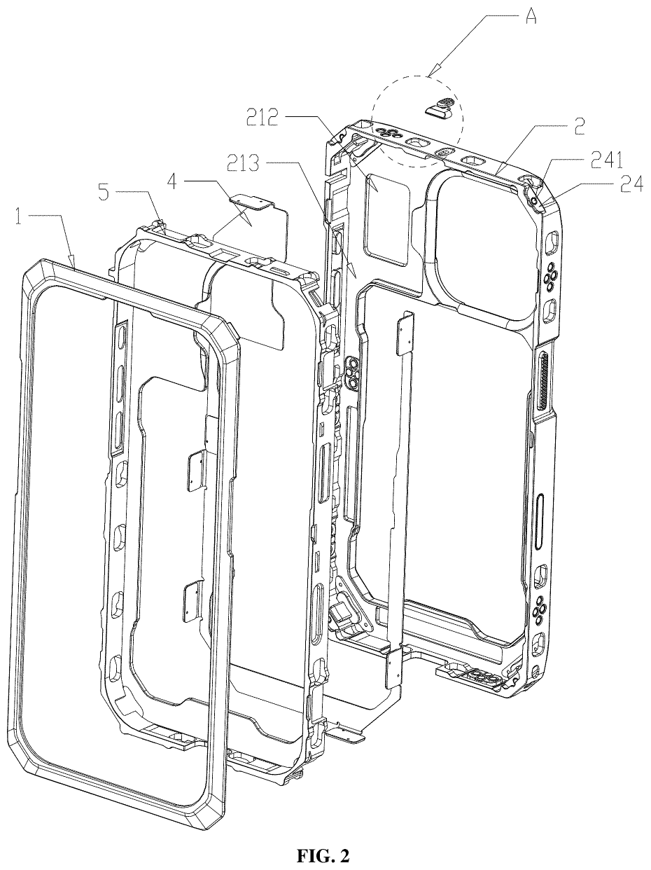

In some aspects, referring to FIGS. 2-4 and 9-10, the assembly component 3 further includes a locking member 33. The locking member 33 is movably connected to either the first housing 1 or the second housing 2, and the other is provided with a locking groove 34. When the latching member 31 engages with the latching groove 32, the locking member 33 can be engaged within the locking groove 34 to lock the first housing 1 and second housing 2 in place. With this arrangement, after the user places the electronic device 20 into the mounting space 21, the first housing 1 can be slid relative to the second housing 2 to enable the latching member 31 to slide into and be engaged within the latching groove 32, and the locking member 33 can engage with the locking groove 34 to lock the first housing 1 and second housing 2 in place. For disassembly, the user can actuate the locking member 33 to disengage it from the locking groove 34, then slide the first housing 1 relative to the second housing 2 in the opposite direction to disengage the latching member 31 from the latching groove 32, enabling the first housing 1 and second housing 2 to be separated and the electronic device 20 to be removed.

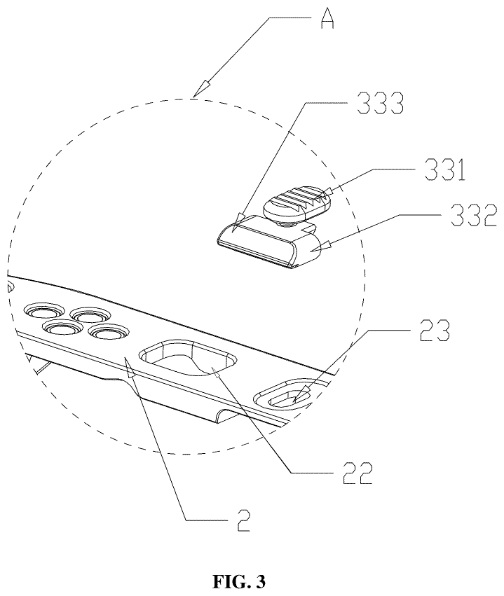

Referring to FIG. 3, the locking member 33 includes an actuating part 331 and a locking pin 332. The locking pin 332 is elastically positioned on either the first housing 1 or the second housing 2, and the actuating part 331 is connected to the locking pin 332. The actuating part 331 can drive the locking pin 332 to engage with or disengage from the locking groove 34. In some aspects, the locking member 33 may be positioned on either the first housing 1 or the second housing 2, and the other is provided with the locking groove 34. For example, for illustrative purposes, the locking member 33 is positioned on the second housing 2. The locking member 33 is elastically positioned on the second housing 2, and the second housing 2 has a first opening 22 and a second opening 23. The locking pin 332 is elastically positioned on the second housing 2, with one end capable of extending beyond the first opening 22. The actuating part 331 is connected to the locking pin 332, with one end capable of extending beyond the second opening 23. For example, the locking pin 332 and the actuating part 331 may be fixed by threading. A spring is provided between the locking pin 332 and the second housing 2 to elastically support the locking pin 332 on the second housing 2. For example, multiple springs can be provided between the locking pin 332 and the second housing 2, uniformly distributed on both sides of the actuating part 331.

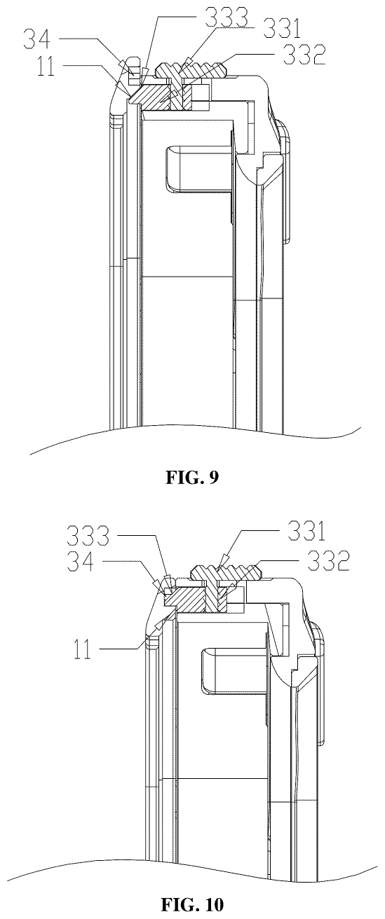

In some aspects, with reference to FIGS. 9-10, the locking member 33 incorporates a first inclined surface 333 (e.g., a tapered or chamfered interface). This surface is inclined from one end of the second housing 2 towards the end adjacent to the first housing 1 to the sliding direction of the first housing 1. Consequently, when the first housing 1 slides relative to the second housing 2, the first inclined surface 333 is pushed or displaced, enabling the locking member 33 to automatically slide into the locking groove 34. In some aspects, considering the locking member 33 is positioned on the second housing 2, the inclination of the first inclined surface 333 from the end of the second housing 2 to the end adjacent to the first housing 1 follows the sliding direction of the first housing 1. As the first housing 1 slides relative to the second housing 2, it abuts against and gradually pushes or urges the first inclined surface 333, causing the locking member 33 to retract relative to the second housing 2. When the first housing 1 and second housing 2 are correctly installed, the first housing 1 moves until the locking groove 34 aligns with the locking member 33, allowing the locking member 33 to spring back into the locking groove 34, thereby completing the automatic sliding process of the locking member 33 into the locking groove 34. This mechanism achieves self-locking for the first housing 1 and second housing 2. For example, in this embodiment, as illustrated in FIGS. 9-10, the sliding direction of the first housing 1 is downward, and the inclination of the first inclined surface 333 from the end of the second housing 2 to the end adjacent to the first housing 1 is also downward, indicating a gradual decrease in the height of the first inclined surface 333 from the end of the second housing 2 to the end adjacent to the first housing 1. As the first housing 1 slides downward, it pushes the first inclined surface 333, causing the locking member 33 to retract. When the first housing 1 stops pushing the first inclined surface 333, the locking member 33 extends into the locking groove 34 under elastic force. In another embodiment, when the locking member 33 is placed on the first housing 1 and slides downward, the second housing 2 can push the first inclined surface 333, causing the locking member 33 to retract relative to the first housing 1. When the first housing 1 slides until the locking groove 34 aligns with the locking member 33, the locking member 33 springs back into the locking groove 34, completing the self-installation of the first housing 1 and second housing 2.

When the locking member 33 is positioned on the second housing 2, the side of the first housing 1 facing the locking member 33 incorporates a second inclined surface 11. The second inclined surface 11 is inclined from one end of the first housing 1 towards the end adjacent to the second housing 2, in a direction opposite to the sliding direction of the first housing 1, enabling it to push the first inclined surface 333 when the first housing 1 slides relative to the second housing 2. With this configuration, as the first housing 1 slides relative to the second housing 2, the second inclined surface 11 abuts against and gradually pushes the first inclined surface 333, causing the locking member 33 to retract relative to the second housing 2. When the first housing 1 and second housing 2 are correctly installed, the first housing 1 moves until the locking groove 34 aligns with the locking member 33, enabling the locking member 33 to spring back into the locking groove 34, thereby achieving self-locking for the first housing 1 and second housing 2. Conversely, when the locking member 33 is positioned on the first housing 1, the second housing 2 can correspondingly incorporate a second inclined surface 11.

In some aspects, the mounting space 21 includes a mounting opening 211 facing a first direction, enabling the electronic device 20 to be placed into the mounting space 21 along its thickness direction. This design facilitates quick placement of the electronic device 20 into the mounting space 21 by the user. The first direction corresponds to the thickness direction of the electronic device 20.

In some aspects, with reference to FIGS. 5-6, the second housing 2 further includes a first positioning groove 24. The latching member 31 includes a latching hook 311, which can slide along the first positioning groove 24 into the latching groove 32. This design allows the user to position the latching hook 311 in the first positioning groove 24 during installation, and then slide the first housing 1 relative to the second housing 2 to engage the latching hook 311 within the latching groove 32.

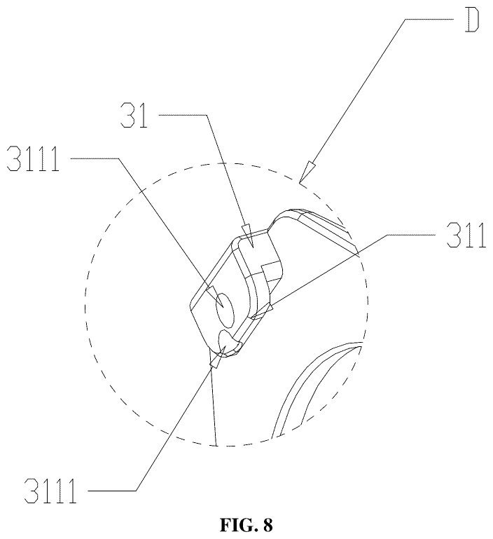

Referring to FIG. 8, the first positioning groove 24 is equipped with a detent ball 241, and the latching hook 311 includes multiple sliding grooves 3111. As the latching hook 311 slides along the first positioning groove 24, the detent ball 241 moves from one sliding groove 3111 to another, providing tactile feedback to the user during sliding and allowing the user to perceive when installation is complete. In some aspects, the detent ball 241 can be commercially available component, and its specific structure is not detailed here.

In some aspects, the latching member 31 includes multiple units, each featuring a latching hook 311. The second housing 2 includes multiple latching grooves 32. The multiple latching members 31 are spaced apart on the first housing 1 and correspond one-to-one in position with the multiple latching grooves 32. The opening direction of the latching hooks 311 is consistent with the sliding direction of the first housing 1. This arrangement ensures a stable connection between the first housing 1 and second housing 2. For example, multiple latching members 31 can be placed at the four corners and the middle portion of the first housing 1, with corresponding latching grooves 32 at the four corners and the middle portion of the second housing 2.

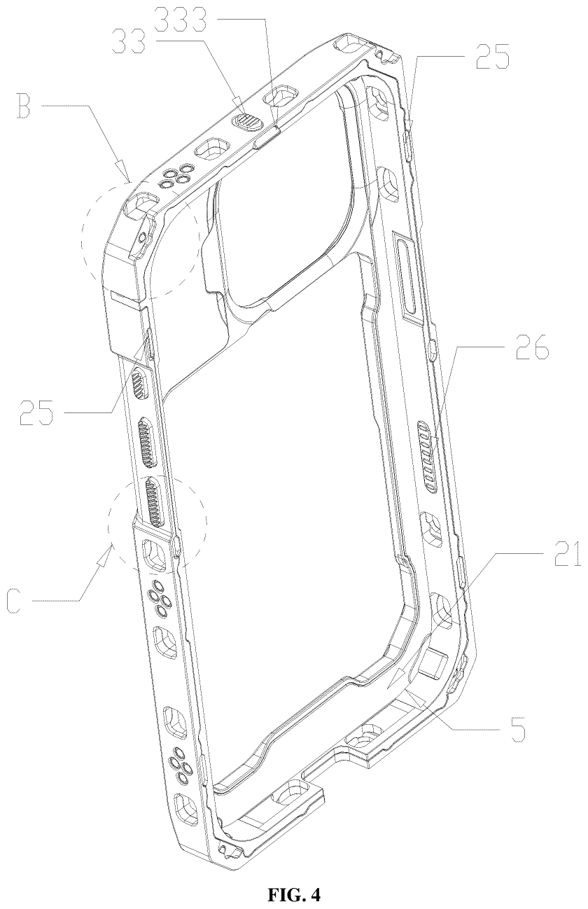

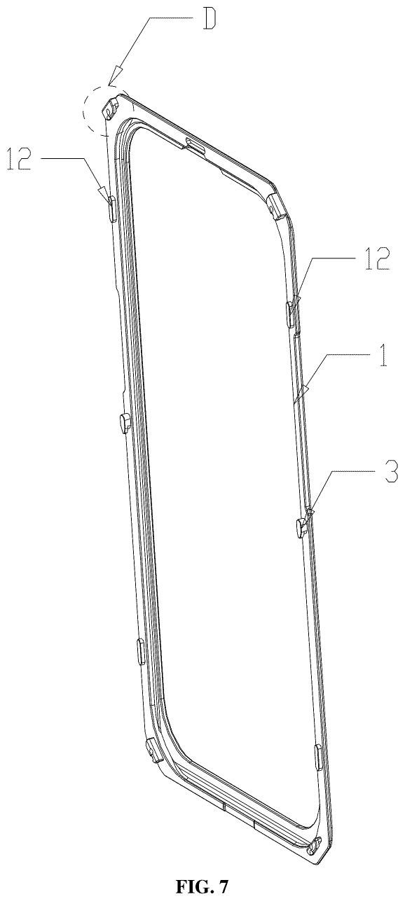

In some aspects, referring to FIGS. 4 and 7, one of the first housing 1 and the second housing 2 includes a second positioning groove 25, while the other includes a positioning post 12. When the first housing 1 slides relative to the second housing 2 along a second direction, the positioning post 12 slides along the second positioning groove 25 to further align and position the first housing 1 and second housing 2 during installation.

In some aspects, the second housing 2 further includes one or more trigger keys (e.g., a trigger key 26), which can be exposed in the mounting space 21 and contact the operational buttons of the electronic device 20. In some aspects, the mounting frame 10 in this embodiment is suitable for electronic devices 20 with operational buttons on the market, such as mobile phones with physical buttons. The trigger key 26 can include a metal conductor contacting the operational buttons or a touchscreen contacting the operational buttons. When a finger touches the trigger key 26, the operational buttons of the electronic device 20 respond to the finger's action.

In some aspects, referring to FIG. 2, the mounting frame 10 further includes a circuit board and a flexible flat cable 4. The inner wall of the second housing 2 facing the mounting space 21 includes an accommodating groove 212 and a wire passage channel 213. The circuit board is housed in the accommodating groove 212, and the flexible flat cable 4 is housed in the wire passage channel 213. The second housing 2 includes multiple first mounting interfaces 27 and multiple second mounting interfaces 28, arranged in a one-to-one correspondence. At least one electrical interface 29 is positioned between a first mounting interface 27 and its corresponding second mounting interface 28. The circuit board is electrically connected to the electrical interface 29 via the flexible flat cable 4. This arrangement enables the mounting frame 10 to be used for installing external accessories and electrically connecting with them, enhancing user convenience. For example, the user can install a mobile phone in the mounting space 21 and expand functionalities by installing accessories such as lights, microphones, or power handles via the first interface 27 and second mounting interface 28. The lights, microphones, and power handles are electrically connected to the mounting frame 10 through the electrical interface 29. Thus, the power handle can be electrically connected to the lights and microphone and can also power them. The electrical interface 29 can include one or more electronic contact pins, and corresponding external accessories can also have electronic contact pins to establish electrical connection upon contact.

In some aspects, the inner wall of the second housing 2 facing the mounting space 21 is equipped with a protective pad 5. The circuit board and the flexible flat cable 4 are positioned between the protective pad 5 and the second housing 2.

Although specific embodiments of the invention have been described in detail, it should be understood that the invention is not limited to the exact configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A mounting frame, comprising:
a first housing;
a second housing, comprising a mounting space for placing an electronic device between the first housing and the second housing;
an assembly component comprising at least one latching member and at least one latching groove,
wherein the at the least one latching member is provided on one of the first housing and the second housing, and the at least one latching groove is provided on the other of the first housing and the second housing; and
wherein the at least one latching member is configured to engage with the at least one latching groove to restrict the electronic device within the mounting space.

2. The mounting frame according to claim 1, wherein the assembly component further comprises a locking member;
wherein the locking member is movably connected to one of the first housing and the second housing, and the other of the first housing and the second housing is provided with a locking groove corresponding to the locking member; and
wherein in response to the at least one latching member latching in the at least one latching groove, the locking member is configured to engage with the locking groove to lock the first housing and the second housing together.

3. The mounting frame according to claim 2, wherein the locking member comprises an actuating part and a locking pin;
wherein the locking pin is elastically disposed on one of the first housing and the second housing;
wherein the actuating part is connected to the locking pin; and
wherein the actuating part is configured to drive the locking pin to move relative to the locking groove.

4. The mounting frame according to claim 3, wherein the first housing is provided with the locking groove;
wherein the second housing is provided with a first opening and a second opening;
wherein the locking pin is elastically disposed on the second housing with one end configured to extend out of the first opening; and
wherein the actuating part is connected to the locking pin with one end capable of extending out of the second opening.

5. The mounting frame according to claim 2, wherein the mounting space is provided with a mounting opening facing a first direction, enabling the electronic device to be placed into the mounting space along a thickness direction of the electronic device.

6. The mounting frame according to claim 2, wherein the latching member is disposed on the first housing;
wherein the latching groove is disposed on the second housing; and
wherein in response to the first housing sliding relative to the second housing, the latching member is configured to latch into the latching groove.

7. The mounting frame according to claim 6, wherein the locking member is provided with a first inclined surface;
wherein the first inclined surface is inclined toward a sliding direction of the first housing from a first end of the second housing to a second end close to the first housing; and
wherein, in response to the first housing sliding relative to the second housing, the first inclined surface is configured to be displaced by the first housing, enabling the locking member to slide into the locking groove.

8. The mounting frame according to claim 7, wherein the locking member is disposed on the second housing;
wherein the locking groove is disposed on the first housing;
wherein a side of the first housing facing the locking member is provided with a second inclined surface;
wherein the second inclined surface is inclined toward the sliding direction of the first housing from one end of the second housing to an end close to the first housing; and
wherein, in response to the first housing sliding relative to the second housing, the second inclined surface is configured to urge the first inclined surface.

9. The mounting frame according to claim 6, wherein the second housing is further provided with a first positioning groove;
wherein the latching member is configured as a latching hook; and
wherein the latching hook is configured to slide along the first positioning groove to the latching groove.

10. The mounting frame according to claim 9, wherein the first positioning groove is provided with one or more detent balls;
wherein the latching hook is provided with multiple sliding grooves; and
wherein in response to the latching hook sliding along the first positioning groove, the detent balls are configured to slide from one sliding groove to another sliding groove among the sliding grooves.

11. The mounting frame according to claim 6, further comprising multiple latching members, each of the latching members is provided with a latching hook;
wherein the second housing is provided with multiple latching grooves; and
wherein the latching members are spaced apart on the first housing, the latching members and the latching grooves are arranged in one-to-one correspondence, and an opening direction of the latching hook is consistent with a sliding direction of the first housing.

12. The mounting frame according to claim 6, wherein one of the first housing and the second housing is provided with a second positioning groove, and the other of the first housing and the second housing comprises a positioning post; and
wherein in response to the first housing sliding relative to the second housing, the positioning post is configured to slide along the second positioning groove.

13. The mounting frame according to claim 1, wherein the second housing is provided with a trigger key; and
wherein the trigger key is configured to be exposed in the mounting space for contacting an operation button of the electronic device.

14. The mounting frame according to claim 1, wherein the mounting frame further comprises a circuit board and a flexible flat cable;
wherein an inner wall of the second housing facing the mounting space is provided with an accommodating groove and a wire passage channel;
wherein the circuit board is accommodated in the accommodating groove;
wherein the flexible flat cable is accommodated in the wire passage channel;
wherein the second housing is provided with multiple first mounting interfaces and multiple second mounting interfaces;
wherein the first mounting interfaces and the second mounting interfaces are arranged in one-to-one correspondence;
wherein at least one electrical interface is disposed between at least one of the first mounting interfaces and a corresponding one of the second mounting interfaces; and
wherein the circuit board is electrically connected to the electrical interface through the flexible flat cable.

15. The mounting frame according to claim 14, wherein the second housing is provided with a protective pad;
wherein the protective pad is disposed on an inner wall of the second housing facing the mounting space;
wherein multiple latching grooves are arranged;
wherein multiple latching members are arranged;
wherein the latching grooves and the latching members are arranged in one-to-one correspondence;
wherein at least a portion of the latching grooves are formed by the protective pad and the second housing; and
wherein the circuit board and the flexible flat cable are disposed between the protective pad and the second housing.
